(19) United States
(12) Patent Application Publication
(10) Pub. No.: US 2026/0295821 A1
(43) Pub. Date: Oct. 1, 2026

(54) APPARATUS AND METHOD FOR ROBOT LEARNING

(71) Applicant: ELECTRONICS AND TELECOMMUNICATIONS RESEARCH INSTITUTE, Daejeon (KR)

(72) Inventors: In Gook JANG, Daejeon (KR); Seong Hyun KIM, Daejeon (KR); Sam Yeul NOH, Daejeon (KR); Hee Chul BAE, Daejeon (KR); Dong Hun LEE, Daejeon (KR)

(21) Appl. No.: 19/396,833

(22) Filed: Nov. 21, 2025

(30) Foreign Application Priority Data
Mar. 26, 2025 (KR) 10-2025-0039125

(51) Int. Cl. B25J 9/16

(52) U.S. Cl. CPC B25J 9/163; B25J 9/1653

(57) ABSTRACT

Provided is an apparatus and method for robot learning, and the apparatus includes: a memory storing at least one instruction; and a processor executing the at least one instruction stored in the memory, wherein the processor collects failure data of a robot related to a failure occurring during a learning process of the robot, generates first feedback data based on the failure data, generates second feedback data based on the first feedback data, constructs a set of first training data based on the second feedback data and the failure data, and trains a cognitive model of the robot based on the set of the first training data, wherein the first feedback data is data obtained by converting the failure data into a form understandable to a human, and the second feedback data is data obtained by converting the first feedback data into a form understandable to the robot.

### CROSS-REFERENCE TO RELATED APPLICATION

This application claims priority to and the benefit of Korean Patent Application No. 10-2025-0039125, filed on Mar 26, 2025, the disclosure of which is incorporated herein by reference in its entirety.

### BACKGROUND

### 1. Field of the Invention

The present invention relates to an apparatus and method for robot learning, which are used for learning of an artificial intelligence (AI)-based robot.

### 2. Discussion of Related Art

With the growing use of AI-based robots, there is an increasing number of situations in which human safety may be threatened due to errors or failures occurring in tasks performed by robots. Failures in robot tasks may lead to economic losses such as decreased productivity, increased maintenance costs, and rising costs for retraining AI models, which delays the industrial adoption of robots. Furthermore, data sets used in robot learning processes are often constructed based on successful task data, which may fail to sufficiently reflect various errors and failure situations in real environments and may cause issues of data bias.

Conventional robot learning technologies have been somewhat biased toward learning based on successful result data, and thus in structured and non-dynamic environments, have been able to achieve high success rates for target tasks (e.g., grasping and moving a previously learned object).

Meanwhile, conventional robot learning technologies lack the function to identify the cause when a robot makes a mistake or fails and to generate interpretable feedback thereon. The lack of feedback makes it difficult for robots to autonomously improve errors and failures occurring during the learning process and consequently may cause the trained AI models to fail to operate reliably in real environments.

The background art of the present invention is disclosed in Korean Laid-Open Patent Publication No. 10-2021-0069410 (Published date: June 11, 2021.

### SUMMARY OF THE INVENTION

The present invention is directed to providing an apparatus and method for robot learning, which are capable of improving adaptability of robots to environments by training a cognitive model and a behavior model of a robot using failure data occurring during a process in which the robot interacts with an environment.

According to an aspect of the present invention, there is provided an apparatus for robot learning, which includes: a memory storing at least one instruction; and a processor executing the at least one instruction stored in the memory, wherein the processor collects failure data of a robot related to a failure occurring during a learning process of the robot, generates first feedback data based on the failure data, generates second feedback data based on the first feedback data, constructs a set of first training data based on the second feedback data and the failure data, and trains a cognitive model of the robot based on the set of the first training data, wherein the first feedback data is data obtained by converting the failure data into a form understandable to a human, and the second feedback data is data obtained by converting the first feedback data into a form understandable to the robot.

The failure data may include state data, action data, and visual data of the robot at a time of occurrence of the failure and before and after the time, and reward data of the robot related to the failure.

The processor may generate the first feedback data from the failure data using a predefined first natural language processing model, and the first natural language processing model is a large language model.

The processor may generate the second feedback data from the first feedback data using a predefined second natural language processing model, and the second natural language processing model may be a large language model.

The apparatus may further include a user interface, wherein the processor may provide the first feedback data to a user through the user interface.

The processor may repeatedly perform a process of configuring the first training data based on the action data, the visual data, and the second feedback data for each piece of the collected failure data to construct the set of the first training data.

The processor may train the cognitive model through representation learning.

The processor may construct a set of second training data based on the second feedback data and the failure data and train a behavior model of the robot based on the set of the second training data.

The processor may repeatedly perform a process of configuring the second training data based on the action data, the visual data, and the second feedback data for each piece of the collected failure data to construct the set of the second training data.

The processor may train a behavior model through policy learning.

According to an aspect of the present invention, there is provided a method for robot learning, which includes: collecting, by a processor, failure data of a robot related to a failure occurring during a learning process of the robot; generating, by the processor, first feedback data based on the failure data; generating, by the processor, second feedback data based on the first feedback data; constructing, by the processor, a set of first training data based on the second feedback data and the failure data; and training a cognitive model of the robot based on the set of the first training data, wherein the first feedback data is data obtained by converting the failure data into a form understandable to a human, and the second feedback data is data obtained by converting the first feedback data into a form understandable to the robot.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating an apparatus for robot learning according to an embodiment of the present invention;

FIG. 2 is an exemplary diagram for describing a processor of the apparatus for robot learning according to an embodiment of the present invention; and

FIG. 3 is a flowchart showing a method for robot learning according to an embodiment of the present invention.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, embodiments of an apparatus and method for robot learning according to the present invention will be described.

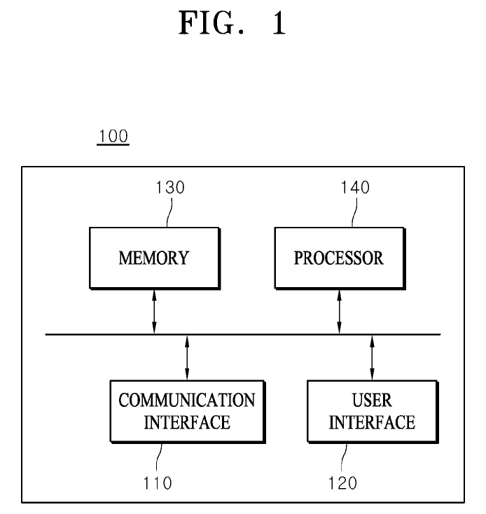

FIG. 1 is a block diagram illustrating an apparatus for robot learning according to an embodiment of the present invention.

Referring to FIG. 1, an apparatus 100 for robot learning according to the embodiment of the present invention may include a communication interface 110, a user interface 120, a memory 130, and a processor 140. The apparatus 100 for robot learning according to the embodiment of the present invention may further include various components in addition to the components shown in FIG. 1 or may not include some of the above-described components.

The communication interface 110 may perform communication with external devices. The communication interface 110 may perform communication with various types of external devices according to various types of communication methods. The communication interface 110 may perform communication with various sensors and devices provided in a robot and may acquire data required for robot learning from the various sensors and devices provided in the robot.

The user interface 120 may be a device for interacting with users. The user interface 120 may include an input device configured to receive user input and an output device configured to deliver information to users. The input device may include a keyboard, a mouse, a touchscreen, and the like. The output device may include a display, a speaker, and the like.

The memory 130 may store at least one instruction executed by the processor 140, which will be described below, in a process of training the robot. The memory 130 may store basic data required for training the robot or data generated by the processor 140 in a process of training the robot, and the processor 140 may access data stored in the memory 130 to perform an operation of training a robot. The memory 130 may be implemented as a computer-readable recording medium and operate to be accessible to the processor 140. Specifically, the memory 130 may be implemented as a hard drive, a magnetic tape, a memory card, a read-only memory (ROM), a random access memory (RAM), or an optical data storage device such as a digital versatile disc (DVD) or an optical disc.

The processor 140, as a subject that performs an operation of training a robot, may be implemented as an application specific integrated circuit (ASIC), a digital signal processor (DSP), a programmable logic device (PLD), a field programmable gate array (FPGA), a central processing unit (CPU), a microcontroller, and/or a microprocessor, and may drive operating systems or applications and control a plurality of hardware or software components. The processor 140 may be configured to execute at least one instruction stored in the memory 130 and store data resulting from the execution in the memory 130.

The processor 140 may collect failure data of the robot related to failures occurring during a learning process of the robot (a process in which the robot interacts with an environment). The failure data may be data recorded by the robot during the learning process, in cases where the robot fails to achieve a goal. For example, the failure data may include state data of the robot at a time of occurrence of the failure and before and after the time, action data of the robot at a time of occurrence of the failure and before and after the time, visual data of the robot at a time of occurrence of the failure and before and after the time, and reward data of the robot related to the failure, but is not limited thereto, and various types of information related to the failure may be included in the failure data

In the present embodiment, the state data of the robot may be information about the states of various sensors and devices included in the robot. In the present embodiment, the reward data of the robot may be information about rewards (feedback values) received as a result of a model performing a specific action. In the present embodiment, the action data of the robot may be information about an action performed by the robot. In the present embodiment, the visual data of the robot may be information about a surrounding environment recognized by the robot. For example, the visual data of the robot may be information detected through recognition sensors (a camera, a LiDAR, a radar, an ultrasonic sensor, etc.) provided in the robot.

The processor 140 may generate first feedback data based on the failure data. The first feedback data may be data obtained by converting the failure data into a form understandable (interpretable) to a human. For example, the first feedback data may correspond to a human readable explanation (HRE). The processor 140 may generate the first feedback data from the failure data using a predefined first natural language processing model. The first natural language processing model may be a large language model (LLM). The processor 140 may analyze the failure data through the first natural language processing model and generate the first feedback data by converting a result of the analysis into natural language interpretable to a human. The result of analyzing the failure data may include information about a failure action of the robot (an action that failed), a failure result of the robot (a result caused by the failed action), a cause of the failure of the robot, a cognitive result of the robot, and the like.

In various embodiments, the processor 140 may also visualize the first feedback data using a visualization model.

The processor 140 may provide the first feedback data to a user through the user interface 120. For example, the processor 140 may output the first feedback data to the user through a display, a speaker, or the like.

The processor 140 may generate second feedback data based on the first feedback data. The second feedback data may be data obtained by converting the first feedback data into a form understandable (interpretable) to the robot. For example, the second feedback data may correspond to machine readable feedback (MRF). The processor 140 may generate the second feedback data from the first feedback data using a predefined second natural language processing model. The second natural language processing model may be an LLM. The processor 140 may generate the second feedback data by converting the first feedback data into machine language interpretable to the robot through the second natural language processing model.

The processor 140 may configure first training data based on the action data of the robot and the visual data of the robot included in the failure data of the robot, and the second feedback data. The first training data may be training data for training a cognitive model of the robot. The processor 140 may preprocess each piece of the data (the action data, the visual data, and the second feedback data) to be in a form suitable for training the cognitive model. For example, the processor 140 may normalize each piece of data. In addition, the processor 140 may perform labeling on the visual data based on the second feedback data. For example, the processor 140 may label the visual data with the cognitive result included in the second feedback data.

The processor 140 may construct a first training data set by repeating a process of configuring first training data for each piece of the collected failure data. In various embodiments, the processor 140 may also augment the first training data to increase the diversity and amount of the first training data.

The processor 140 may train the cognitive model of the robot based on the first training data set. The processor 140 may train the cognitive model of the robot through representation learning. The processor 140 may enhance the cognitive performance of the robot for environments through the representation learning.

The present embodiment may improve the cognitive performance of the robot for environments by training the cognitive model of the robot using the failure data of the robot and thus support the robot in appropriately recognizing the environment in various situations.

The processor 140 may configure second training data based on the action data and the visual data of the robot included in the failure data of the robot and the second feedback data. The second training data may be training data for training the behavior model of the robot. The processor 140 may preprocess each piece of the data (the action data, the visual data, and the second feedback data) to be in a form suitable for training the behavior model. For example, the processor 140 may normalize each piece of data. In addition, the processor 140 may perform labeling on action data based on the second feedback data. For example, the processor 140 may label the action data with the failure result included in the second feedback data.

The processor 140 may construct a second training data set by repeating a process of configuring second training data for each piece of the collected failure data. In various embodiments, the processor 140 may also augment the second training data to increase the diversity and amount of the second training data.

The processor 140 may train the behavior model of the robot based on the second training data set. The processor 140 may train the behavior model of the robot through policy learning. The processor 140 may improve the performance of the behavior model of the robot through policy learning.

In various embodiments, the processor 140 may train the cognitive model of the robot based on the first and second training data sets. That is, the processor 140 may use not only the first training data set but also the second training data set to train the cognitive model of the robot. In various embodiments, the processor 140 may train the behavior model of the robot based on the first and second training data sets. That is, the processor 140 may use not only the second training data set but also the first training data set to train the behavior model of the robot.

The present embodiment may train the behavior model using the failure data of the robot and thus support the robot in performing appropriate actions in various situations.

Meanwhile, in the above-described embodiment, only the failure data of the robot has been described as being used for robot learning, but not only the failure data of the robot but also success data of the robot may be used for robot learning in the same manner as described above.

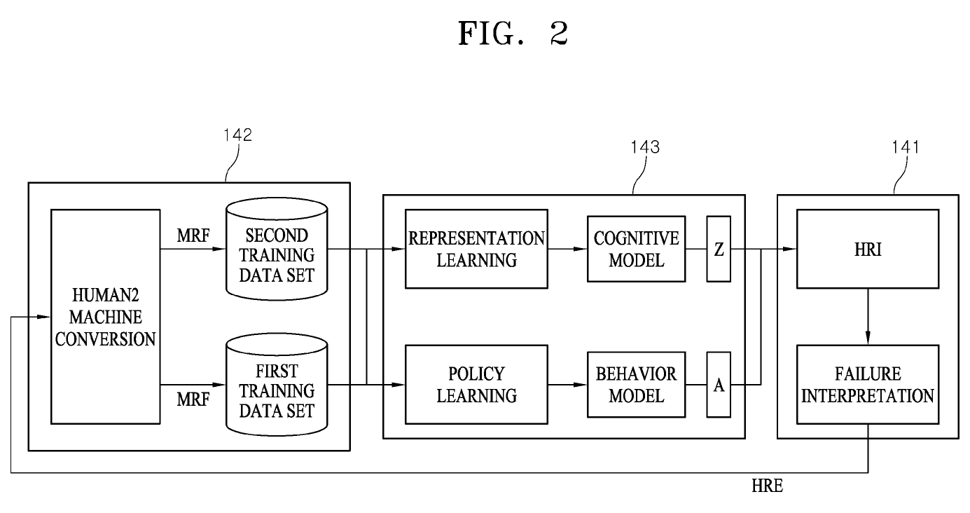

FIG. 2 is an exemplary diagram for describing the processor of the apparatus for robot learning according to an embodiment of the present invention.

Referring to FIG. 2, the processor 140 may include an interpretation module 141, a conversion module 142, and a training module 143. In the present embodiment, a module denotes a component responsible for some operations of the processor 140 classified according to functions, and the operations performed by each module may be understood as operations performed by the processor 140.

The interpretation module 141 may generate first feedback data (HRE) based on failure data of the robot. The interpretation module 141 may convert failure data of the robot into a form understandable (interpretable) to a human. The interpretation module 141 may generate the first feedback data from the failure data using a predefined first natural language processing model. The interpretation module 141 may analyze the failure data through the first natural language processing model and generate the first feedback data by converting a result of the analysis into natural language interpretable to a human.

The interpretation module 141 may provide the first feedback data to a user. The interpretation module 141 may provide the first feedback data to the user by visualizing the first feedback data using a visualization model. The interpretation module 141 may perform interaction with the user (human robot interaction, HRI) regarding the failure situation of the robot through the user interface 12).

The conversion module 142 may generate second feedback data (MRF) based on the first feedback data. The conversion module 142 may convert the first feedback data into a form understandable (interpretable) to the robot (human-to-machine conversion). The conversion module 142 may generate the second feedback data from the first feedback data using a predefined second natural language processing model. The conversion module 142 may generate the second feedback data by converting the first feedback data into machine language interpretable to the robot through the second natural language processing model.

The conversion module 142 may configure first training data based on behavior data and visual data of the robot included in the failure data and the second feedback data. The conversion module 142 may construct a first training data set by repeating a process of configuring the first training data for each piece of the collected failure data. The conversion module 142 may also augment the first training data to increase the diversity and amount of the first training data.

The conversion module 142 may configure second training data based on behavior data and visual data of the robot included in the failure data and the second feedback data. The conversion module 142 may construct a second training data set by repeating a process of configuring the second training data for each piece of the collected failure data. The conversion module 142 may also augment the second training data to increase the diversity and amount of the second training data.

The training module 143 may train a cognitive model of the robot based on the first training data set. The training module 143 may train the cognitive model of the robot through representation learning. The training module 143 may enhance the cognitive performance of the robot with respect to the environment through representation learning. The cognitive model may output information Z on a recognition result when robot-related data is input.

The training module 143 may train a behavior model of the robot based on the second training data set. The training module 143 may train the behavior model of the robot through policy learning. The training module 143 may improve the performance of the behavior model of the robot through policy learning. The behavior model may output information A on an action to be performed when robot-related data is input.

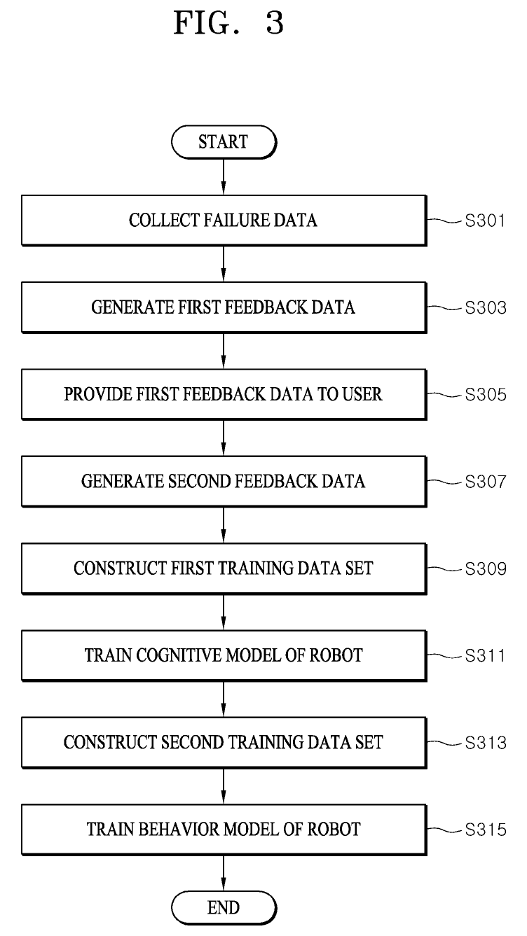

FIG. 3 is a flowchart showing a method for robot learning according to an embodiment of the present invention.

Hereinafter, referring to FIG. 3, a process of training a robot will be described. Some of the following operations may be performed in an order different from that described below or may be omitted.

First, the processor 14 may collect failure data of a robot related to failures occurring during a learning process of the robot (S301)

Next, the processor 14 may generate first feedback data based on the failure data of the robot (S303). The first feedback data may be data obtained by converting the failure data into a form understandable (interpretable) to a human. In operation S303, the processor 14 may analyze the failure data through a first natural language processing model and generate the first feedback data by converting a result of the analysis into natural language interpretable to a human.

Next, the processor 14 may provide the first feedback data to a user through the user interface 120 (S305).

Next, the processor 14 may generate second feedback data based on the first feedback data (S307). The second feedback data may be data obtained by converting the first feedback data into a form understandable (interpretable) to the robot. The processor 14 may generate the second feedback data by converting the first feedback data into machine language interpretable to the robot through a second natural language processing model.

Next, the processor 14 may construct a first training data set by repeatedly performing a process of configuring first training data based on behavior data and visual data of the robot included in the failure data and the second feedback data (S309).

Next, the processor 14 may train a cognitive model of the robot based on the first training data set (S311). In operation S311, the processor 14 may train the cognitive model of the robot through representation learning.

Next, the processor 14 may construct a second training data set by repeatedly performing a process of configuring second training data based on behavior data and visual data of the robot included in the failure data and the second feedback data (S313).

Next, the processor 14 may train a behavior model of the robot based on the second training data set (S315). In operation S315, the processor 14 may train the behavior model of the robot through policy learning. Operations S313 and S315 may be performed simultaneously or in parallel with operations S309 and S311.

According to aspects of the present invention, adaptability of robots to environments can be improved by training a cognitive model and a behavior model of a robot using failure data occurring during a process in which the robot interacts with an environment.

As described above, the apparatus and method for robot learning according to an embodiment of the present invention can improve the adaptability of a robot to an environment by training a cognitive model and a behavior model of the robot using failure data occurring in a process of the robot interacting with the environment.

What is claimed is:

1. An apparatus for robot learning, comprising:
a memory storing at least one instruction; and
a processor executing the at least one instruction stored in the memory,
wherein the processor is configured to:
collect failure data of a robot related to a failure occurring during a learning process of the robot;
generate first feedback data based on the failure data;
generate second feedback data based on the first feedback data;
construct a set of first training data based on the second feedback data and the failure data; and
train a cognitive model of the robot based on the set of the first training data,
wherein the first feedback data is data obtained by converting the failure data into a form understandable to a human, and the second feedback data is data obtained by converting the first feedback data into a form understandable to the robot.

2. The apparatus of claim 1, wherein the failure data includes state data, action data, and visual data of the robot at a time of occurrence of the failure and before and after the time, and reward data of the robot related to the failure.

3. The apparatus of claim 1, wherein the processor generates the first feedback data from the failure data using a predefined first natural language processing model, and
the first natural language processing model is a large language model.

4. The apparatus of claim 1, wherein the processor generates the second feedback data from the first feedback data using a predefined second natural language processing model, and
the second natural language processing model is a large language model.

5. The apparatus of claim 1, further comprising a user interface,
wherein the processor provides the first feedback data to a user through the user interface.

6. The apparatus of claim 2, wherein the processor repeatedly performs a process of configuring the first training data based on the action data, the visual data, and the second feedback data for each piece of the collected failure data to construct the set of the first training data.

7. The apparatus of claim 1, wherein the processor trains the cognitive model through representation learning.

8. The apparatus of claim 2, wherein the processor is configured to:
construct a set of second training data based on the second feedback data and the failure data; and
train a behavior model of the robot based on the set of the second training data.

9. The apparatus of claim 8, wherein the processor repeatedly performs a process of configuring the second training data based on the action data, the visual data, and the second feedback data for each piece of the collected failure data to construct the set of the second training data.

10. The apparatus of claim 8, wherein the processor trains a behavior model through policy learning.

11. A method for robot learning, comprising:
collecting, by a processor, failure data of a robot related to a failure occurring during a learning process of the robot;
generating, by the processor, first feedback data based on the failure data;
generating, by the processor, second feedback data based on the first feedback data;
constructing, by the processor, a set of first training data based on the second feedback data and the failure data; and
training a cognitive model of the robot based on the set of the first training data,
wherein the first feedback data is data obtained by converting the failure data into a form understandable to a human, and the second feedback data is data obtained by converting the first feedback data into a form understandable to the robot.

12. The method of claim 11, wherein the failure data includes state data, action data, and visual data of the robot at a time of occurrence of the failure and before and after the time, and reward data of the robot related to the failure.

13. The method of claim 11, wherein the generating of the first feedback data includes generating the first feedback data from the failure data using a predefined first natural language processing model, and
the first natural language processing model is a large language model.

14. The method of claim 11, wherein the generating of the second feedback data includes generating the second feedback data from the first feedback data using a predefined second natural language processing model, and
the second natural language processing model is a large language model.

15. The method of claim 11, further comprising, after the generating of the first feedback data,
providing, by the processor, the first feedback data to a user through a user interface.

16. The method of claim 12, wherein the constructing of the set of the first training data includes repeatedly performing, by the processor, a process of configuring the first training data based on the action data, the visual data, and the second feedback data for each piece of the collected failure data to construct the set of the first training data.

17. The method of claim 11, wherein the training of the cognitive model of the robot includes training, by the processor, the cognitive model through representation learning.

18. The method of claim 12, further comprising, after the generating of the second feedback data,
constructing, by the processor, a set of second training data based on the second feedback data and the failure data, and
training a behavior model of the robot based on the set of the second training data.

19. The method of claim 18, wherein the constructing of the set of the second training data includes repeatedly performing, by the processor, a process of configuring the second training data based on the action data, the visual data, and the second feedback data for each piece of the collected failure data to construct the set of the second training data.

20. The method of claim 18, wherein the training of the behavior model of the robot includes training, by the processor, the behavior model through policy learning.
